(19) United States
(12) Patent Application Publication
(10) Pub. No.: US 2015/0262251 A1
(43) Pub. Date: Sep. 17, 2015

(54) APPARATUS AND METHOD FOR ADVERTISING

(71) Applicant: KANFIELD CAPITAL SA, Panama (PA)

(72) Inventor: Thomas Christian Knobel, Panama City (PA)

(73) Assignee: KANFIELD CAPITAL SA, Panama (PA)

(21) Appl. No.: 14/212,764

(22) Filed: Mar. 14, 2014

(51) Int. Cl. G06Q 30/02

(52) U.S. Cl. CPC G06Q 30/0273

(57) ABSTRACT

Methods and apparatus of determining and communicating end user credit for an account associated with a telecommunications network based on delivery of advertising content to telecommunication devices associated with the end user and hierarchically related telecommunication devices are disclosed. The end user credit may be based, at least in part, on a hierarchical relationship between telecommunication devices associated with multiple end users of the network, as well as information concerning the delivery of advertising content over the telecommunication network to the devices associated with the end users.

### FIELD OF THE INVENTION

The present invention relates generally to a system and method for distributing advertising to end users of a network accessed by a telecommunications device

### BACKGROUND OF THE INVENTION

Telecommunication devices, such as, but not limited to, smart phones, desk top computers, laptop computers, and tablet computers may be used to provide communication between an end user device and one or more other devices. Communication between these telecommunication devices may be provided in the form of voice, text messaging, instant messaging, sound (e.g., audible alerts), video, picture, or multi-media information. All of these modes of communication normally require the use of the one or more networks to carry the communications to and from the end user devices.

The cost of building, maintaining and operating these telecommunication networks can be significant. Many network operators (e.g. carriers) charge end users, in one form or another, for use of the network to deliver such communications. These charges may be in the form of flat monthly fees, per session fees, per call fees, calling card purchases, or the like. End users are naturally attracted to use networks with the lowest access fees. Accordingly, some network operators may reduce or eliminate the fees charged to end users by subsidizing the cost of operation with advertising revenues generated from use of the network. For example, several large television networks have operated without charging any fees to end users (i.e., viewers) of the network by charging fees to advertisers for the delivery of advertisements to the viewers in conjunction with non-advertising content.

Further, targeted advertising has been known as an effective method for converting consumers of advertising content to purchasers. When the consumer receives only relevant advertisements from a provider, the consumer is more likely to patronize the particular provider, make purchases, and provide additional personal information that may assist in refining the provider's “view” of the consumer. As such, targeted advertising can lead to a more focused and robust interaction with the consumer. This, correspondingly, can lead to a more rewarding interaction for the provider by generating increased revenue.

In order to effectively target a consumer, it may be desirable for marketing systems to react to consumer information received from a variety of online and offline sources. These sources may include databases and servers, as well as multiple web properties within a network of affiliated websites. Moreover, the consumer information may be collected from a variety of sources in diverse formats, including from the consumer herself. It may also be desirable for marketing systems to interact with the systems that actually deliver the content to the user. In short, an effective marketing system may appreciate the characteristics and preferences of a specific user regardless of the number or type of channels through which contact with the user is made.

While end users appreciate the reduction or elimination of network access fees as a result of the delivery of advertising to them over the network, they have little incentive to expose themselves to more than the minimum amount of advertising required. Different end users may have different tolerances levels for exposure to advertising. Accordingly, a network that maximizes advertising content to minimize the network access fees that must be charged to end users, may be unsatisfactory to end users with lower tolerance for advertising exposure. Thus, there is a tension between the desire of an end user to incur minimal network access fees, with the desire of the end user to be exposed to a tolerable level of advertising.

Embodiments of the present invention accommodate delivery of content such as advertisements to telecommunication devices associated with end users through a telecommunications network, including computer networks. Embodiments of the present invention can be embodied in various forms, including business processes, computer implemented methods, computer program products, computer systems and networks, user interfaces, application programming interfaces, and the like.

### SUMMARY OF THE INVENTION

Responsive to the foregoing challenges, Applicant has developed a method for crediting an account associated with an end user telecommunication device in connection with use of a telecommunication network connecting a server and client side telecommunication devices, the method comprising: providing a server to communicate with first and second telecommunication devices; registering the first and second telecommunication devices with the server; determining, using a processor associated with the server, a hierarchical relationship between the first and second telecommunication devices; storing, in a computer memory associated with the server, an indicator of the hierarchical relationship of the first and second telecommunication devices; storing, in the computer memory, information concerning delivery of advertising content over the telecommunication network to the second telecommunication device; determining, using the processor, an end user credit for the first telecommunication device based at least in part on the indicator of the hierarchical relationship of the first and second telecommunication devices, and based at least in part on the information concerning the delivery of the advertising content over the telecommunication network to the second telecommunication device; and transmitting, under the direction of the server, a signal to the first telecommunication device based on the determined end user credit, said signal being adapted to produce a physically perceptible output of the determined end user credit.

Applicant has further developed a method for crediting an account associated with an end user telecommunication device in connection with use of a telecommunication network connecting a server and client side telecommunication devices, the method comprising: providing a server to communicate with first, second and third telecommunication devices; registering the first, second and third telecommunication devices with the server; determining, at the server, a hierarchical relationship between the first and second telecommunication devices; determining, at the server, a hierarchical relationship between the second and third telecommunication devices; storing, in a computer memory associated with the server, an indicator of the hierarchical relationship of the first and second telecommunication devices and an indicator of the hierarchical relationship of the second and third telecommunication devices; storing, in the computer memory, information concerning delivery of advertising content over the telecommunication network to the third telecommunication device; determining an end user credit for the first telecommunication device based at least in part on the indicator of the hierarchical relationship of the first and second telecommunication devices, based at least in part on the indicator of the hierarchical relationship of the second and third telecommunication devices, and based at least in part on the information concerning delivery of advertising content over the telecommunication network to the third telecommunication device; and transmitting a signal to the first telecommunication device and/or other computer associated with the first telecommunication device based on the determined end user credit, said signal being adapted to produce a physically perceptible output of the determined end user credit.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements. The drawings are exemplary only, and should not be construed as limiting the invention.

FIG. 1 is a schematic illustration of a system including a telecommunication network and multiple telecommunication devices in accordance with embodiments of the present invention.

FIG. 2 is a schematic illustration of a method for registering telecommunication devices with a server in accordance with embodiments of the present invention.

FIG. 3 is a schematic illustration of a method of determining an end user credit in accordance with an embodiment of the present invention.

FIGS. 4 and 5 are illustrations of hierarchical relationships between multiple telecommunication devices in accordance with embodiments of the invention.

FIG. 6 is an illustration of the variation of end user credits that may be determined in accordance with embodiments of the invention.

### DETAILED DESCRIPTION OF EMBODIMENTS OF THE INVENTION

The various methods discussed herein may be implemented between telecommunication devices that are connected through a telecommunication network or over the Internet. One skilled in the art will recognize that the present invention can be implemented using any type of communication device, including but not limited to conventional telephones, wireless telephones, cell telephones, pagers, personal digital assistants (PDAs), personal communication devices, PDAs, smart phones, or any communication device capable of transmitting and receiving information, including, for example, handheld email devices, handheld computers, desktop computers, laptop computers, tablets, and the like. Accordingly, any particular structure and design of the telecommunication devices is merely one example of a physical device for implementing the techniques of the present invention, and is referred to for illustrative purposes and not to imply any limitations on the scope of the present invention. To the extent that embodiments of the present invention require electronic components and circuits, which are generally known to those skilled in the art, circuit details are not specified in order to not detract from the teachings of the present invention.

The telecommunication devices may each include a screen, which may be a liquid crystal display (LCD), or other type of display for presenting output to the user, including representations of dialing buttons, menus, and the like. The telecommunication device may also include one or more mechanisms for accepting input from the user. In one embodiment, the screen is touch-sensitive, so that the user may interact with the telecommunication device by touching or writing on the surface of screen using a stylus, finger, or other object. Touch screens may receive inputs other than those used to select numeric or text symbols. For example, a touch screen may be rubbed or receive a patterned tactile input. In another embodiment, in addition to, or as a surrogate for, the touch-sensitive screen, the telecommunication device may also include a QWERTY keyboard, or any other type of keyboard or button based interface, for enabling rapid entry of an input, including text, and may further include buttons for performing various other functions associated with the operation of the telecommunication device and its applications, and/or a mouse or joystick.

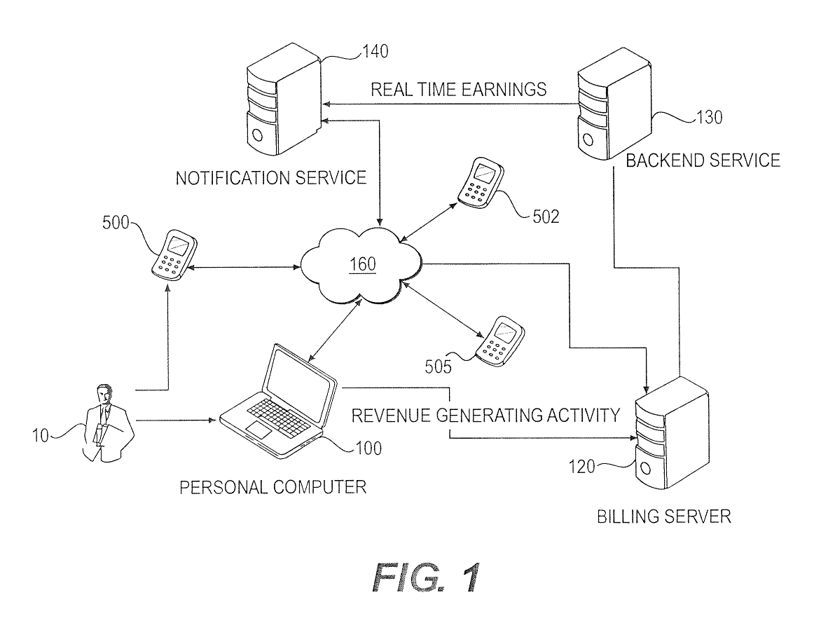

Reference will now be made in detail to a first embodiment of the present invention, an example of which is illustrated in the accompanying drawings. A system that may be used to provide the method embodiments of the present invention is illustrated in FIG. 1. With reference to FIG. 1, the system may include a computer telecommunication device 100 having user input capability and a display. The computer 100 may be associated with a user 10 and a first telecommunication device 500. The computer 100 may serve as a telecommunication device and communicate directly or indirectly over one or more telecommunication links with one or more network operator servers, including a billing server 120, a backend server 130 and a notification server 140. In alternative embodiments, the number of servers may be reduced or expanded, so long as the services required are provided by the group of servers. It is intended that references herein to a server incorporate systems in which the same or discrete server devices provide the functions of the recited server. The Internet or any other telecommunication network(s) 160, alone or in combination, may provide the required telecommunication links for operation of embodiments of the invention.

The telecommunication network 160 may support communication between the notification server 140 and the first, second and third telecommunication devices 500, 502 and 505. The first telecommunication device 500, the second telecommunication device 502 and the third telecommunication device 505 may also communicate with each other using the one or more telecommunication networks 160. The telecommunication network(s) 160 may facilitate voice, pictorial, video, SMS, and/or other data communication between the telecommunication devices connected thereto.

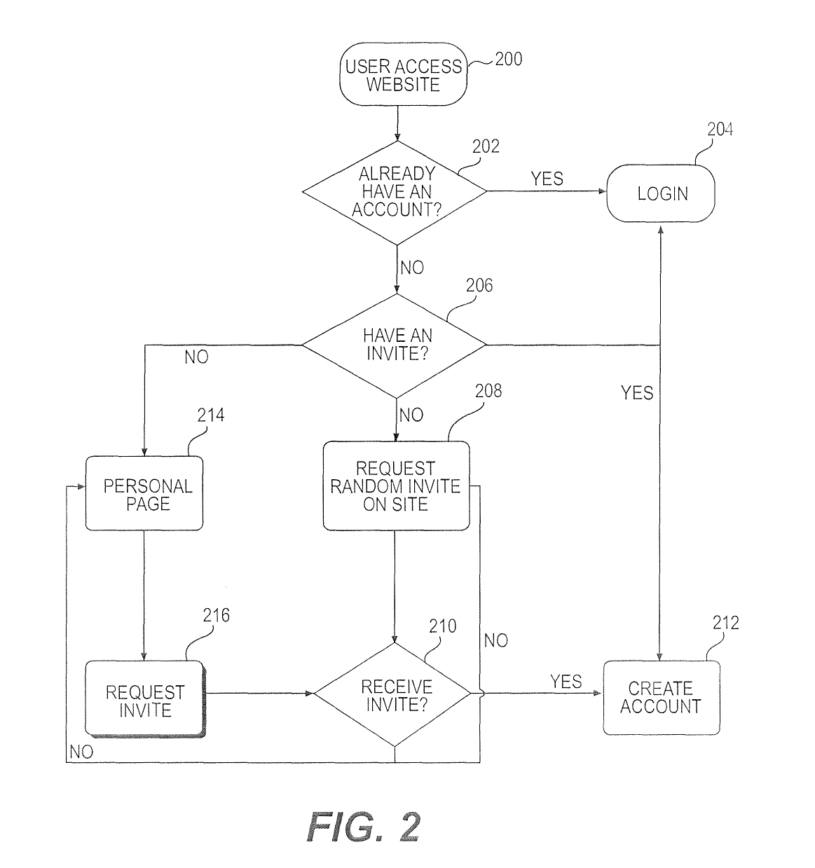

FIG. 2 illustrates an exemplary method of registering the computer telecommunication device 100 and the first, second and third telecommunication devices 500, 502 and 505, with one or more of the network operator servers 120, 130 and 140, shown in FIG. 1. With reference to FIG. 2, in step 200, the end users may use their respective telecommunication devices 100, 500, 502 and 505 (shown in FIG. 1) to access a website associated with the network operator. In step 202, one of the servers associated with the network operator may determine from a computer memory whether there is an account already associated with the particular telecommunication device. If an account is determined to already exist, the server may transmit login information to the telecommunication device being used in step 204, for logging in to the network as a registered end user. The server may function similarly to transmit login information to the other telecommunication devices, as needed.

If no account exists, in step 206, one or more of the network operator servers may determine if an invite to become part of an end user network was sent to and/or received by the telecommunication device attempting to register from an account associated with a different telecommunication device. If an invite had been sent or received, the server may transmit information to the telecommunication device attempting to register to create a new account for it in step 212. After the creation of the new account, the telecommunication device attempting to register may be used to log in to the network as a registered end user in step 204.

When an account is created for the first telecommunication device 500, for example, as a result of an invite from another telecommunication device, an indicator of a hierarchical relationship between the telecommunication device that has just newly registered and the telecommunication device from which the invite was received is stored in a computer memory associated with one or more of the network operator servers 120, 130 and 140.

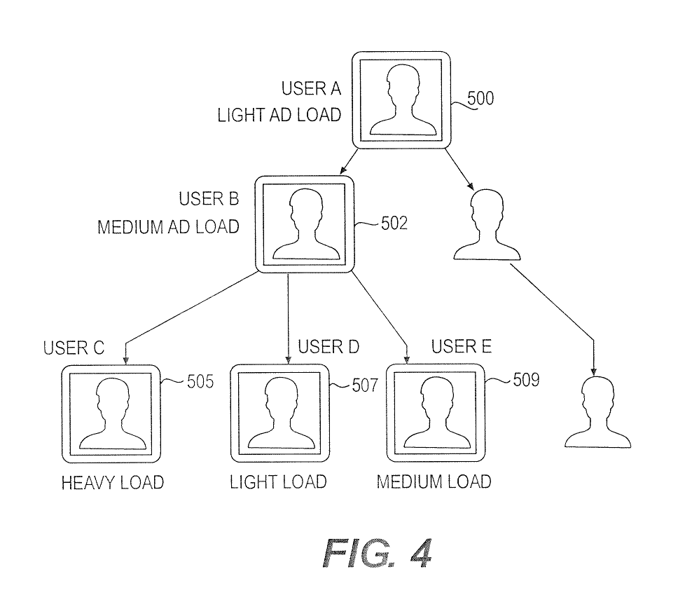

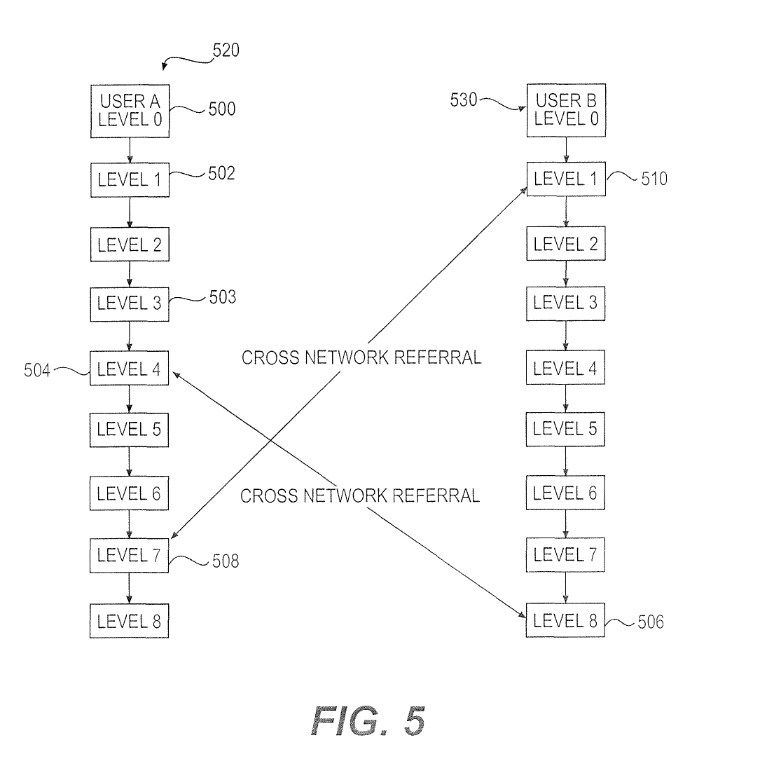

For example, with reference to FIG. 4, if the telecommunication device from which the invite is received is the first telecommunication device 500, then the second telecommunication device 502 may be the one that has just newly registered based on the invite. As shown, second telecommunication device 502 is one hierarchical level below (Level 1) the first telecommunication device 500. All telecommunication devices which register as a result of an invite from device 500 will be part of Level 1 with respect to their hierarchical relationship to device 500. And all of the telecommunication devices which populate Level 1 through Level n below device 500 (e.g., with reference to FIGS. 4-5, devices 502, 503, 504, 507, 508 and 509) will be part of the end user network 520 associated with the first telecommunication device 500. An eight level hierarchy, shown in FIG. 5, is contemplated to be preferred, but the number of hierarchical levels beyond two may be varied without departing from the intended scope of the invention.

With renewed reference to FIG. 2, if it is determined in step 206 that no invite has been sent to, or received by, the telecommunication device attempting to register, the telecommunication device may request an invite to join an end user network in one of two ways. In a first method of joining the network, in step 208, the telecommunication device attempting to register may be used to request an invite to be associated hierarchically with a random telecommunication device that is already a member of an end user network, such as user network 520 in FIG. 5. The random telecommunication device may be automatically selected by the network server following digitally stored instructions, or the network server may automatically send a message to one or more registered telecommunication devices in accordance with digitally stored instructions, advertising that the telecommunication device attempting to register is requesting an invite to join an existing user network. For example, with reference to FIG. 5, telecommunication device 504 in Level 4 of end user network 520 may have registered with end user network 520 as the result of a randomly generated invite from telecommunication device 503 in Level 3.

With renewed reference to FIG. 2, in step 210, it may be determined automatically by a network server, operating in accordance with stored instructions, whether the telecommunication device attempting to register received an invite. If an invite was not received, a network server may automatically reinitiate the process of requesting a random invite in step 208 and the process may repeat until the telecommunication device attempting to register receives a random invite. Once the random invite is received, the telecommunication device attempting to register may be automatically associated in computer memory with the end user network associated in computer memory with the telecommunication device from which the random invite was generated in step 212 in accordance with digitally stored instructions. Thereafter, the telecommunication device which has registered may be used to log in to the network in step 204.

Returning to step 206, in accordance with an alternative subroutine, the telecommunication device attempting to register may be used to request an invite from a particular, i.e., non-random, other telecommunication device by visiting a personal page associated with the other telecommunication device in step 214. Once the personal page is visited, the telecommunication device attempting to register may be used to request an invite from the telecommunication device associated with a particular end user in step 216.

In step 210, it may be automatically determined by a network server, following digitally stored instructions, whether the telecommunication device attempting to register received an invite from the telecommunication device associated with the particular end user. If an invite was not received, the telecommunication device attempting to register may reinitiate the process of requesting an invite from the telecommunication device associated with another particular end user in step 214, and the process may repeat until the telecommunication device attempting to register receives an invite. Once an invite is received, the end user may accept the invite thereby causing the telecommunication device attempting to register to automatically be associated in computer memory with the end user network associated with the telecommunication device from which the random or non-random invite was generated in step 212. Thereafter, the telecommunication device which has just registered may be used to log in to the network in step 204.

The foregoing process may be repeated for multiple telecommunication devices in order to populate a hierarchy of interrelated telecommunication devices. The hierarchical relationship of all registered telecommunication devices may be automatically stored in a computer memory associated with the server(s) used for registration in accordance with stored computer instructions. An alternative view of such a hierarchy is illustrated in FIG. 4 in which the hierarchical relationship of a first telecommunication device 500 associated with end user A, is shown with respect to second telecommunication device 502 associated with end user B, and with third, fourth and fifth telecommunication devices 505, 507 and 509, associated with end users C, D and E, respectively. In FIG. 4, the first telecommunication device 500 associated with User A is hierarchically related to, and hierarchically above, the second telecommunication device 502 associated with User B. The first and second telecommunication devices 500 and 502 are separated by one level in the hierarchy. The first telecommunication device 500 is further hierarchically related to, and hierarchically above, the third, fourth and fifth telecommunication devices 505, 507 and 509. The first telecommunication device 500 is separated from the third, fourth and fifth telecommunication devices 505, 507 and 509 by two levels in the hierarchy. The number of levels separating the first telecommunication device 500 from the other referenced telecommunication devices has a bearing on the automatic computer generated determination of end user credit for the first telecommunication device resulting from the delivery of advertising content to the telecommunication devices with which it has a relationship lower in the hierarchy, as explained in detail below.

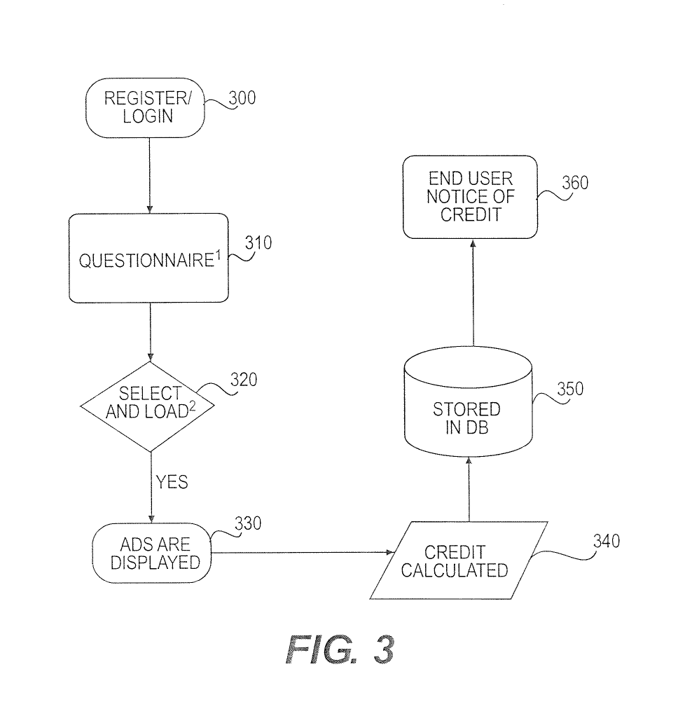

The manner in which one or more accounts associated with the various telecommunication devices may be automatically determined, using a computer processor, to have earned end user credit is illustrated by FIG. 3. The steps in FIG. 3 are intended to illustrate machine interaction between the various telecommunication devices referenced and a server (comprising one or more discrete servers) which is associated with a computer processor(s) and computer memory shown in FIG. 1.

With reference to FIGS. 1 and 3, in step 300, the first, second and third telecommunication devices 500, 502 and 505 may already be registered such that there is a computer memory stored indicator of a hierarchical relationship between them. Once the first, second and third telecommunication devices 500, 502 and 505, are registered, each of the telecommunication devices from which it is desired to earn end user credit must log into the telecommunication network associated with the network server. Login may be retried and passwords reset, as needed. In this example, it may be assumed that at least the second and third telecommunication devices 502 and 505 are logged in. It is not required that the first telecommunication device 500 be logged in to receive credit. Only those telecommunication devices that are earning credit for hierarchically related telecommunication devices must be logged into the network.

In step 310, once login is successful, a questionnaire may be automatically presented to the end users via the telecommunication devices 502 and 505 under the direction of the server. The questionnaire may be presented each time the user logs in, or periodically, for completion or updating. Alternatively, the questionnaire may be presented only once, at initial login, and thereafter updated or completed at the discretion of the end user. The questionnaire may require that the end user provide indications of personal, preference, and/or demographic information. Such information may include, but not be limited to information such as preferred foods, movies, movie genres, actors, musical performers and groups, music genres, books, book genres, television programs, television genres, websites, sports, theater, entertainment, travel locations, travel means, travel lodging, retail stores, shopping locations, consumer goods, hobbies, and the like. Personal and demographic information may include, but not be limited to age, gender, marital status, number of children, age of children, gender of children, residence, employer, employer location, income level, and the like. The end user may complete the questionnaire in whole or in part and the information provided may be transmitted electronically from the end user's telecommunication device to the server. The server may automatically store the information received in connection with the questionnaire in a computer memory and associate such information with an account for the telecommunication device from which it was received. The eventual determination of an end user credit to be associated with the telecommunication device with which the end user is associated may be based at least in part on the degree of completion of the questionnaire, as explained below.

In step 320, the server may automatically send an electronic transmission to the first and second telecommunication devices 502 and 505, requesting that the end user select an advertisement load level. The system server(s) 120/130/140 may present the end user with the option of selecting from two or more load levels of advertisement exposure. Higher levels of advertisement load may provide relatively higher levels of end user credit. For example, in one embodiment of the invention, the end user may use her telecommunication device to select from light, medium or heavy advertisement load levels. Selection of a light advertisement load level may provide the lowest level of end user credit, while selection of a heavy advertisement load level may provide the highest level of end user credit. The selected advertisement load levels may be automatically transmitted to the server(s) 120/130/140 and stored in a computer memory automatically. In this manner, the advertisement load levels for the second and third telecommunication devices 502 and 505 may be associated in a computer memory with accounts for such devices. It should be noted that an indication of advertisement load level stored in computer memory for a telecommunication device is considered to constitute information concerning delivery of advertising content over the telecommunication network to the telecommunication device.

The selection of advertisement load level for a telecommunication device may be used to determine the accumulation of end user credit earned as the result of use of the network by other telecommunication devices with which it is hierarchically related. For example, with reference to FIG. 4, user A has selected a light advertisement load level for the first telecommunication device 500. Further, user B has selected a medium advertisement load level for the second telecommunication device 502 and user C has selected a heavy advertisement load level for the third telecommunication device 505. In such a scenario, the end user credit earned for the account associated with the first telecommunication device 500 as the result of network use by the second and third telecommunication devices 502 and 505, may be based, at least in part, on the advertisement load level stored in memory for the hierarchically related second and third telecommunication devices 502 and 505.

In a preferred embodiment, the advertisement load level which is stored in memory for the telecommunication device earning user credit as a result of being hierarchically related to other telecommunication devices may determine the maximum credit that can be earned based on network usage. In the example illustrated by FIG. 4, the first telecommunication device 500 is associated with a light advertisement load level, and as a result, the automatic determination of the end user credit for the account for the first telecommunication device as a result of network use by the second and third telecommunication devices 502 and 505, is calculated based on the second and third telecommunication devices getting credit for only being associated with a light advertisement load level. In an alternative example, if the first telecommunication device 500 was associated with a medium advertisement load level, then the account for the first telecommunication device would earn credit for network use by the second and third telecommunication devices 502 and 505 at the medium advertisement load level. In a still further example, if the first telecommunication device 500 was associated with a heavy advertisement load level, then the account for the first telecommunication device would earn credit for network use by the second telecommunication device 502 at the medium advertisement load level, and credit for the network use by the third telecommunication device 505 at the heavy advertisement load level. Since the end user credit earned may be higher for telecommunication devices associated in memory with relatively higher advertisement load levels, this method of end user credit determination encourages all users to register for relatively higher advertisement load levels.

The advertising load level selected may be used by the computer to automatically determine: the advertisement positions in a visual presentation on the telecommunication device, the advertisement size in a visual presentation on the telecommunication device, advertisement duration over a time period on the telecommunication device, the number of advertisements presented on the telecommunication device over time or at one time, and/or targeting advertisements for the end user based on answers provided to the questionnaire. Specifically, memory storage of a relatively higher advertising load level for a given telecommunication device may cause the computer to instruct the system to transmit a higher number of advertisements in a given time period, and/or advertisements having more prominent screen locations, larger sizes, and/or longer durations, and/or less targeted advertisements to the telecommunication device with which such load level is associated.

In step 330, the second and third telecommunication devices 502 and 505 may be operated in a manner that requires network usage. For example, the second and third telecommunication devices 502 and 505 may be used to browse the Internet, send or receive email, participate in a telephone call, or text message. The network usage may be of the type for which there is normally a charge. The network server may automatically accrue charges for the network usage by the second and third telecommunication devices 502 and 505. If the network usage ceases, the calculated cost of such usage may be automatically determined and stored in a computer memory for an accounts associated with the second and third telecommunication device 502 and 505.

As a result of being associated with a medium advertisement load level, advertisements may be automatically served to the second telecommunication device 502 at a medium advertisement load level in step 330. As a result of being associated with a heavy advertisement load level, advertisements may be automatically served to the third telecommunication device 505 at a heavy advertisement load level. Advertising content or advertisements, as used herein, may include any content for which an entity is willing to provide compensation for it being delivered to an end user via a telecommunication device.

In step 340, end user credit for the telecommunication devices which are hierarchically related to the second and third telecommunication devices 502 and 505 may be calculated. With reference to FIG. 4, both the second and third telecommunication devices 502 and 505 have a hierarchical relationship with the first telecommunication device 500 in which the first telecommunication device is higher in the hierarchy (Level 0 versus Level 1 and Level 2). Further, the second telecommunication device 502 may have a hierarchical relationship with the third telecommunication device 505 in which the second telecommunication device is higher in the hierarchy (Level 1 versus Level 2). As a result of the existence of these hierarchical relationships, the accounts associated with the telecommunication devices higher in the hierarchy may accrue end user credit as a result of the telecommunication device lower in the hierarchy using the telecommunication network. Further, the amount of the end user credit earned may be based on the number of levels separating the telecommunication devices in the hierarchical relationship.

For example, in step 340, it may be determined at a network server that a hierarchical relationship exists between the first and second telecommunication devices 500 and 502, and that the first telecommunication device is higher in such hierarchy. Further, it may be determined at the network server that a hierarchical relationship exists between the first and third telecommunication devices 500 and 505, and between the second and third telecommunication devices 502 and 505, and that the first and second telecommunication devices are each higher in their respective hierarchies. An end user credit may be automatically determined by computer for the first telecommunication device 500 based at least in part on the indicator of the hierarchical relationship of the first and second telecommunication devices 500 and 502, based in part on the indicator of the hierarchical relationship of the first and third telecommunication devices 500 and 505, based at least in part on the information concerning the use of the telecommunication network by the second and third telecommunication devices, and based in part on information concerning the delivery of advertising content (i.e., advertisement load level) over the telecommunication network to the first, second and third telecommunication devices. Further, an end user credit may be automatically determined by computer for the second telecommunication device 505 based at least in part on the indicator of the hierarchical relationship of the second and third telecommunication devices 502 and 505, based at least in part on the information concerning the use of the telecommunication network by the third telecommunication device, and based at least in part on information concerning the delivery of the advertising content (i.e., advertisement load level) over the telecommunication network to the second and third telecommunication devices.

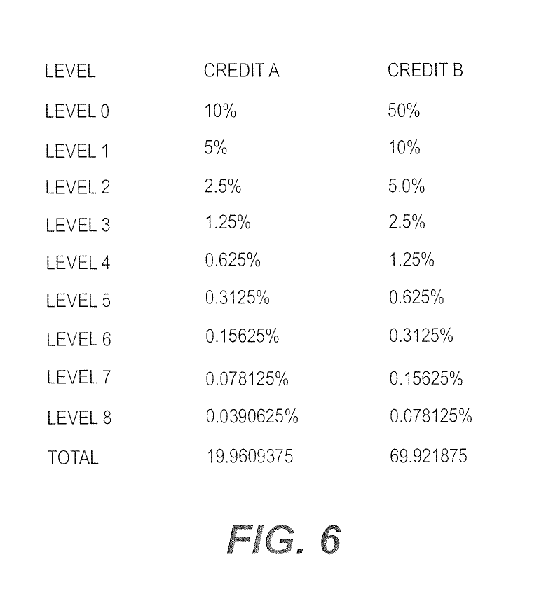

The amount of end user credit earned for the account associated with the telecommunication device which is higher in the hierarchy may be dependent upon the number of levels separating the hierarchically higher telecommunication device from the hierarchically lower telecommunication device. For example, with reference to FIG. 6, following credit plan A, the account for the first telecommunication device 500 may earn a five percent (5%) credit of the charge for network usage made by the second telecommunication device 502 because the two devices are separated hierarchically by one level. Further, the first telecommunication device 500 may earn a two and a half percent (2.5%) credit of the charge for the network usage by the third telecommunication device 505 because the two devices are separated hierarchically by two levels. Still further, in this example, the second telecommunication device 502 may earn a five percent (5%) credit of the charge for network usage by the third telecommunication device 505 because the two devices are separated hierarchically by one level. The foregoing percentage amounts are intended to be examples, and are not intended to limit the scope of the invention. The percentage amounts used may vary without departing from the intended scope of the invention.

Further, with reference to FIG. 5, it should be noted that each level in the illustrated user networks, such as user network 520, may have multiple telecommunication devices associated with each level that are hierarchically related to the telecommunication device above it in the hierarchy. For example, with respect to user network 520, there may be ten (10) telecommunication devices in Level 1 which are hierarchically one level below telecommunication device 500. There may be ten (10) telecommunication devices in Level 2 which are hierarchically one level below each telecommunication device in Level 1, for a total of one hundred (100) devices in Level 2 hierarchically related to telecommunication device 500 in Level 0. This pattern may be repeated such that there may be as many as 1,000 telecommunications devices in Level 3 related to telecommunication device 500 in Level 0, and so on.

A self-earnings credit may also be automatically determined in step 340 by the computer processor for the second and third telecommunication devices 502 and 505, resulting from their use of the network and being associated with an advertisement load level. For example, the amount of self-earnings credit determined for the account associated with the second telecommunication device 502 resulting from use of the network may be based at least in part on the information concerning the use of the telecommunication network by the second telecommunication device, and based at least in part on information concerning the delivery of the advertising content (i.e., advertisement load level) over the telecommunication network to the second telecommunication device. Relatively higher duration or frequency of use of the network and the higher advertisement load level may result in a relatively higher self-earnings credit.

In step 350, the determined end user credit and/or self-earnings credits may be stored in a database associated with the network server, and payments (or end user credits) may be “paid” to the accounts associated with the affected telecommunication devices in the user network. In this example, the payments or credits would be made to at least the accounts associated with the first and second telecommunication devices 500 and 502.

In step 360, the notification of payment or end user credit to the accounts associated with the first and second telecommunication devices 500 and 502 may be physically provided by transmitting a signal to the first telecommunication device 500 based on the determined end user credit, said signal being adapted to produce a physically perceptible output of the determined end user credit, and by transmitting a signal to the second telecommunication device 502 based on the determined end user credit, said signal being adapted to produce a physically perceptible output of the determined end user credit.

The notifications transmitted to the first, second and third telecommunication devices 500, 502 and 505 may include an indication of the end user credit and/or self-earnings credit that was not earned due to the advertisement load level associated with the telecommunication device which has earned some end user credit. For example, the first telecommunication device may receive a notification that indicates the amount of end user credit that was not earned (i.e., forgone or lost) as a result of the first telecommunication device being associated in computer memory with a light advertisement load level as opposed to a medium and/or heavy advertisement load level.

It is also appreciated that a telecommunication device may be registered with the network and hierarchically related to other telecommunication devices, but receive no end user credit because the telecommunication device is not associated with any advertisement load level in computer memory. For example, the first telecommunication device 500 may not be associated with any advertisement load level, but still hierarchically related to the second and third telecommunication devices 502 and 505 which are associated with advertisement load levels, as explained above. In such a scenario, use of the network by the second and third telecommunication devices 502 and 505 may result in a determination of the end user credit that the first telecommunication device 500 would have earned had it been associated with an advertisement load level, and a notification may be automatically generated by a computer and sent to the first telecommunication device indicating the end user credit that could have been earned.

As discussed above, the present invention is not limited to a device resembling the particular telecommunication device described above. In particular, the invention may be implemented in other types of devices and using other types of input and output mechanisms. In addition, the above-described techniques can be used in connection with any type of information or communication mode associated with a contact, including, for example, SMS addresses or handles, email addresses, presence information, and the like. Moreover, the above-described techniques can be used in connection with a group call when the caller calls one or more than one recipient.

The present invention also relates to an apparatus for performing the operations herein. The algorithms and displays presented herein are not inherently related to any particular computer, network of computers, or other apparatus. Various general-purpose systems may be used with programs in accordance with the teachings herein, or it may prove convenient to construct more specialized apparatus to perform the required method steps. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. The required structure for a variety of these systems appears from the description. In addition, the present invention is not described with reference to any particular programming language. It will be appreciated that a variety of programming languages may be used to implement the teachings of the invention as described herein.

As will be understood by those skilled in the art, the invention may be embodied in other specific forms without departing from the spirit or essential characteristics thereof. For example, the particular architecture depicted above are merely exemplary of one implementation of the present invention. The functional elements and method steps described above are provided as illustrative examples of one technique for implementing the invention; one skilled in the art will recognize that many other implementations are possible without departing from the present invention as recited in the claims. In addition, the present invention may be implemented as a method, process, user interface, computer program product, system, apparatus, or any combination thereof. Accordingly, the disclosure of the present invention is intended to be illustrative, but not limiting, of the scope of the invention. It is intended that the present invention cover all such modifications and variations of the invention, provided they come within the scope of the appended claims and their equivalents.

What is claimed is:

1. A method for crediting an account associated with an end user telecommunication device in connection with use of a telecommunication network connecting a server and client side telecommunication devices, the method comprising:
providing a server to communicate with first and second telecommunication devices;
registering the first and second telecommunication devices with the server;
determining, using a processor associated with the server, a hierarchical relationship between the first and second telecommunication devices;
storing, in a computer memory associated with the server, an indicator of the hierarchical relationship of the first and second telecommunication devices;
storing, in the computer memory, information concerning delivery of advertising content over the telecommunication network to the second telecommunication device;
determining, using the processor, an end user credit for the first telecommunication device based at least in part on the indicator of the hierarchical relationship of the first and second telecommunication devices, and based at least in part on the information concerning the delivery of the advertising content over the telecommunication network to the second telecommunication device; and
transmitting, under the direction of the server, a signal to the first telecommunication device based on the determined end user credit, said signal being adapted to produce a physically perceptible output of the determined end user credit.

2. The method of claim 1, further comprising the step of displaying the physically perceptible output of the determined end user credit at the first telecommunication device.

3. The method of claim 1, further comprising:
determining an end user credit for the second telecommunication device based at least in part on the information concerning the delivery of advertising content over the telecommunication network to the second telecommunication device; and
transmitting a signal to the second telecommunication device based on the determined end user credit for the second telecommunication device, said signal being adapted to produce a physically perceptible output of the determined end user credit for the second telecommunication device.

4. The method of claim 1, further comprising:
storing, in the computer memory, information concerning an advertising load level for the first telecommunication device;
wherein determining the end user credit for the first telecommunication device is based at least in part on the advertising load level for the first telecommunication device.

5. The method of claim 4, further comprising:
storing, in the computer memory, information concerning an advertising load level for the second telecommunication device;
wherein determining the end user credit for the first telecommunication device is based at least in part on the advertising load level for the second telecommunication device.

6. The method of claim 1, further comprising:
storing, in the computer memory, information concerning an advertising load level for the second telecommunication device;
wherein determining the end user credit for the first telecommunication device is based at least in part on the advertising load level for the second telecommunication device.

7. The method of claim 1 wherein the hierarchical relationship is determined based on a referral relationship between the first and second telecommunication devices.

8. The method of claim 1 wherein the output of the determined end user credit represents virtual currency.

9. The method of claim 1 wherein the output of the determined end user credit represents actual currency.

10. The method of claim 1 wherein the end user credit for the first telecommunication device is applied in real time to an account associated with the first telecommunication device.

11. A method for crediting an account associated with an end user telecommunication device in connection with use of a telecommunication network connecting a server and client side telecommunication devices, the method comprising:
providing a server to communicate with first, second and third telecommunication devices;
registering the first, second and third telecommunication devices with the server;
determining, using a processor associated with the server, a hierarchical relationship between the first and second telecommunication devices;
determining, using the processor, a hierarchical relationship between the second and third telecommunication devices;
storing, in a computer memory associated with the server, an indicator of the hierarchical relationship of the first and second telecommunication devices and an indicator of the hierarchical relationship of the second and third telecommunication devices;
storing, in the computer memory, information concerning delivery of advertising content over the telecommunication network to the third telecommunication device;
determining, using the processor, an end user credit for the first telecommunication device based at least in part on the indicator of the hierarchical relationship of the first and second telecommunication devices, based at least in part on the indicator of the hierarchical relationship of the second and third telecommunication devices, and based at least in part on the information concerning delivery of advertising content over the telecommunication network to the third telecommunication device; and
transmitting, under the direction of the server, a signal to the first telecommunication device based on the determined end user credit, said signal being adapted to produce a physically perceptible output of the determined end user credit.

12. The method of claim 11, further comprising the steps of:
determining an end user credit for the second telecommunication device based at least in part on the indicator of the hierarchical relationship of the second and third telecommunication devices, and based at least in part on the information concerning delivery of advertising content over the telecommunication network to the third telecommunication device; and
transmitting a signal to the second telecommunication device based on the determined end user credit, said signal being adapted to produce a physically perceptible output of the determined end user credit.

13. The method of claim 12 wherein the end user credit for the second telecommunication device is greater than the end user credit for the first telecommunication device.

14. The method of claim 12 wherein the end user credit for the second telecommunication device is different than the end user credit for the first telecommunication device.

15. The method of claim 11, further comprising the step of displaying the physically perceptible output of the determined end user credit at the first telecommunication device.

16. The method of claim 11, further comprising the steps of:
determining an end user credit for the third telecommunication device based at least in part on the information concerning the delivery of advertising content over the telecommunication network to the third telecommunication device; and
transmitting a signal to the third telecommunication device based on the determined end user credit for the third telecommunication device, said signal being adapted to produce a physically perceptible output of the determined end user credit.

17. The method of claim 11 wherein the hierarchical relationship of the first and second telecommunication devices is determined based on a referral relationship between the first and second telecommunication devices, and
wherein the hierarchical relationship of the second and third telecommunication devices is determined based on a referral relationship between the second and third telecommunication devices.

18. The method of claim 11, further comprising:
storing, in the computer memory, information concerning an advertising load level for the first telecommunication device;
wherein determining the end user credit for the first telecommunication device is based at least in part on the advertising load level for the first telecommunication device.

19. The method of claim 18, further comprising:
storing, in the computer memory, information concerning an advertising load level for the second telecommunication device;
wherein determining the end user credit for the first telecommunication device is based at least in part on the advertising load level for the second telecommunication device.

20. The method of claim 19, further comprising:
storing, in the computer memory, information concerning an advertising load level for the third telecommunication device;
wherein determining the end user credit for the first telecommunication device is based at least in part on the advertising load level for the third telecommunication device.

21. The method of claim 11, further comprising:
storing, in the computer memory, information concerning an advertising load level for the second telecommunication device; and
determining an end user credit for the second telecommunication device based at least in part on the advertising load level for the second telecommunication device.

22. The method of claim 21, further comprising:
storing, in the computer memory, information concerning an advertising load level for the third telecommunication device;
wherein determining the end user credit for the second telecommunication device is based at least in part on the advertising load level for the third telecommunication device.

23. The method of claim 22, further comprising determining an end user credit for the third telecommunication device based at least in part on the advertising load level for the third telecommunication device.

24. The method of claim 11 wherein the end user credit for the first telecommunication device is applied in real time to an account associated with the first telecommunication device.

25. The method of claim 4 wherein the advertising load level is determined by a factor selected from the group consisting of: advertisement position in a visual presentation, advertisement size in a visual presentation, advertisement duration over a time period, number of advertisements, and targeting of an advertisement.

26. The method of claim 1 wherein the end user credit for the first telecommunication device is determined based in part on a degree of completion of a questionnaire associated with the second telecommunication device.

27. The method of claim 26 wherein the end user credit for the first telecommunication device is determined based in part on a degree of completion of a questionnaire associated with the first telecommunication device.

28. A method for notifying an end user telecommunication device of an unearned credit for an account associated with the end user telecommunication device based on use of a telecommunication network connecting a server and client side telecommunication devices, the method comprising:
providing a server to communicate with first and second telecommunication devices;
registering the first and second telecommunication devices with the server;
determining, using a processor associated with the server, a hierarchical relationship between the first and second telecommunication devices;
storing, in a computer memory associated with the server, an indicator of the hierarchical relationship of the first and second telecommunication devices;
storing, in the computer memory, information concerning delivery of advertising content over the telecommunication network to the second telecommunication device;
determining, using the processor, an unearned end user credit for the first telecommunication device based at least in part on the indicator of the hierarchical relationship of the first and second telecommunication devices, and based at least in part on the information concerning the delivery of the advertising content over the telecommunication network to the first and second telecommunication devices; and
transmitting, under the direction of the server, a signal to the first telecommunication device based on the determined unearned end user credit, said signal being adapted to produce a physically perceptible output of the determined unearned end user credit.
